(19) United States
(12) Patent Application Publication
(10) Pub. No.: US 2013/0232328 A1
(43) Pub. Date: Sep. 5, 2013

(54) METHOD TO SAFELY REPROGRAM AN FPGA

(71) Applicant: Ronald Douglas Johnson, Westfield, IN (US)

(72) Inventor: Ronald Douglas Johnson, Westfield, IN (US)

(73) Assignee: THOMSON LICENSING, Issy de Moulineaux (FR)

(21) Appl. No.: 13/884,313

(22) PCT Filed: Sep. 21, 2011
(86) PCT No.: PCT/US11/52438

§ 371 Date: May 9, 2013

Related U.S. Application Data
(60) Provisional application No. 61/414,981, filed on Nov. 18, 2010.

(51) Int. Cl. G06F 9/44

(52) U.S. Cl. CPC G06F 9/4401
USPC 713/2

(57) ABSTRACT

One FPGA provides a multiplexer that allows a host CPU to directly access a second FPGA's memory for upgrading. The second FPGA acts as a buffer and does not participate directly in the upgrade. This permits safer loading and minimizes the impact of a power interruption during upgrading. The architecture can be expanded to any number of FPGA's and any type of software/firmware loading, allowing system programming with a very low risk of catastrophic failure.

This application claims priority from U.S. Provisional Application No. 61/414,981 filed 18 Nov. 2010.

### BACKGROUND

A field programmable gate array is an integrated circuit that can be programmed by a customer “in the field.” This means that it can be configured by the end user to do any number of functions. To perform these functions, the FPGA must be loaded with instructions when it first starts or boots. There are many different FPGA boot loaders in existence. These boot loaders are typically running on a microprocessor and boot from two possible images. However, if one image fails to boot, a flag is set and the next time the FPGA boots, it will be from the other image.

### SUMMARY

Field Programmable Gate Arrays (FPGAs) are used in an architecture that promotes reliable boot loading. For example, in a two FPGA architecture, one FPGA provides a multiplexer that allows a host CPU to directly access the second FPGA's memory for upgrading. The second FPGA acts as a buffer and does not participate directly in the upgrade. This permits safer loading and minimizes the impact of a power interruption during upgrading. The architecture can be expanded to any number of FPGA's and any type of software/firmware loading, allowing system programming with a very low risk of catastrophic failure.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 shows an example processor, namely an Intel® brand IXP425 Network Processor, utilized in one embodiment.

FIG. 2 illustrates the IXP425 boot sequence for a given embodiment.

FIG. 3 shows a master boot sequence for a given embodiment.

FIG. 4 depicts a boot sequence for the slave FPGA for a given embodiment.

FIG. 5 illustrates the factory image LVDS bus line utilization for a given embodiment.

FIG. 6 shows the application LVDS bus line utilization for a given embodiment.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As used in this application, the term “component” is intended to refer to hardware, software, or a combination of hardware and software in execution. For example, a component can be, but is not limited to being, a process running on a processor, a processor, an object, an executable, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

When provided by a processor or microprocessor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting instances and embodiments of the invention are intended to encompass both structural and functional equivalents. Additionally, it is intended that such equivalents include both currently known equivalents as well as equivalents developed in the future (i.e., any elements developed that perform the same function, regardless of structure).

Some FPGA based systems are in remote locations and are very difficult to access. For example, the system can be installed on an airplane or in a harsh environment and the like. Thus, repairing the system in the event of a failure, in the airplane example, is an extreme challenge, requiring service people to travel to a location where the airplane is taken out of service until the repairs are performed. This is both costly and time consuming.

Therefore, a very safe way to perform an in-system upgrade is needed such that, even in the event of a power failure during the upgrade, the system is still fully recoverable. In another example, a system utilizes an Electrically Erasable Programmable Read-Only Memory (EEPROM) that needs to be programmed. In this scenario, the EEPROM is at the end of a chain of two FPGAs.

A manufacturer's suggested way to reprogram the FPGAs in this example is to create a central processing unit (CPU) or state machine in each FPGA that can be communicated with and have them program their own EEPROMs. That is the typical way to program the first and second FPGA's EEPROM. Write code on the second FPGA to accept data from the first FPGA and perform the programming and write code on the first FPGA to accept data from a host CPU and perform the programming of its EEPROM.

In sharp contrast, the disclosed methods are much less complex and use a second FPGA as a buffer—leaving the first FPGA in direct control of the second FPGA's EEPROM. The First FPGA is built with an internal multiplexer that allows the host CPU direct access to the EEPROM and, after coming out of reset, a CPU on that part boots up and verifies and or writes to the EEPROM connected to the second FPGA.

As a specific example, a system is given that contains two types of circuit boards with FPGAs on them. A complete system consists of four slave boards and one master board. Each board contains one of the FPGAs. Each FPGA is attached to an external boot device. The SLAVE FPGA has a serial EEPROM 2MByte EPCS16. The MASTER FPGA is connected to a 16MByte Numonyx PC28F128P30 Flash. Each FPGA contains what is called a “Factory Image.” The factory image has the following characteristics. The job of the factory image is to allow the application image to be loaded.
The factory image is never overwritten. It is protected from writes by the FPGA firmware. This protects the overall system from application write failures.
The factory image must be programmed into the flash prior to attempts to run the application software.
The factory image can only be changed using external programming tools.
The factory image is not OTP locked inside the flash.
The MASTER factory image loads from the PC28F128P30 base address 0x20000.
The SLAVE factory image loads from the EPCS16 base address 0x0.

The application image for both the MASTER and SLAVE can either be pre-programmed in the factory or downloaded later using a standard upgrade mechanism. The MASTER flash memory contains both an application image for the MASTER and the SLAVE. It contains both since the MASTER FPGA manages the upgrade of the SLAVE FPGA. If the application image is corrupted or out of date in the SLAVE Serial EEPROM, the MASTER automatically fixes the SLAVE' s application image. Example MASTER/SLAVE memory maps are shown in TABLEs 1 and 2 below.

TABLE 1
MASTER MEMORY MAP EXAMPLE
MASTER FPGA PC28F128P30 Flash Memory Map

| BLOCK | START ADDRESS | END ADDRESS |
|---|---|---|
| Available | 0x00000000 | 0x0001FFFF |
| Factory | 0x00020000 | 0x003C660F |
| MASTER App | 0x00200000 | 0x003C660F |
| SLAVE App | 0x00400000 | 0x00459D88 |
| Available | 0x00500000 | 0x00FFFFFF |

TABLE 2
SLAVE MEMORY MAP EXAMPLE
SLAVE FPGA EPCS16 Serial EEPROM Memory Map

| BLOCK | START ADDRESS | END ADDRESS |
|---|---|---|
| Page_0 | 0x00000000 | 0x00059D88 |
| Page_1 | 0x00100000 | 0x00159D88 |

Note:
All the addresses are byte addresses

The last 32 bytes of the MASTER App and the SLAVE App are reserved for the version numbers, which are programmed last, after validating that the image is valid and has been written correctly.

The boot sequence and in field programming are discussed together since reprogramming is managed during the boot sequence. In order for the MASTER to be able to directly program the SLAVE EPCS16 serial EEPROMS, the LVDS (low voltage differential signaling) bus lines are repurposed. More details on this are given in following discussions.

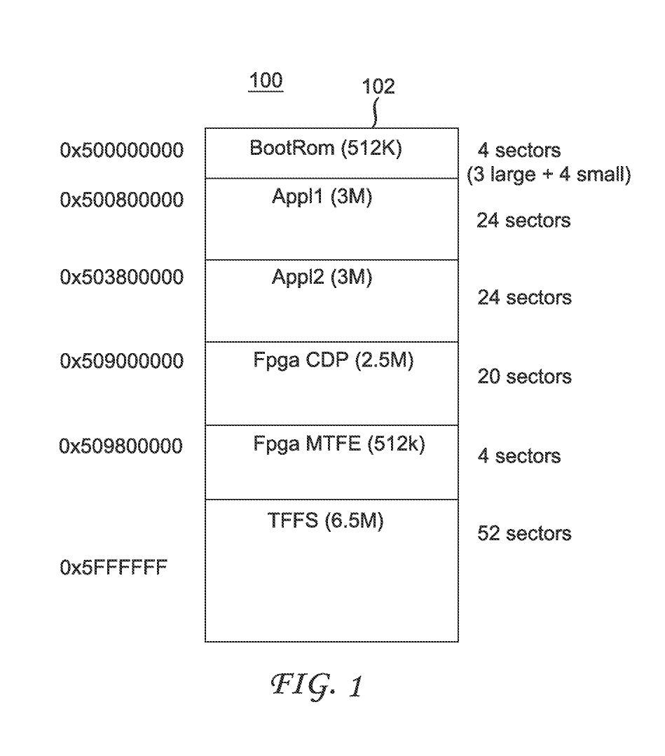

As a further example 100, a processor 102, namely an Intel® IXP425 Network Processor, is utilized (see FIG. 1). The IXP425 manages a user interface for loading the FPGA firmware modules via the MIBs (management information base). The DSCD code (Differential Synchronization of Code and Data) is loaded as a concatenated image file through the mxuSwAdmin MIB. The image contains the MASTER software, the MASTER FPGA firmware and the SLAVE FPGA firmware, which is broken out into the binary images and loaded into the main flash when initiated by SNMP (Simple Network Management Protocol). The memory map below shows the locations where the MASTER and SLAVE images are stored on the main flash. The last 32 bytes of the MASTER and SLAVE images contains the version number of the firmware, which derives from the filename of the SLAVE binary file. The version number is the last thing that is written after the firmware has been written and verified.

When the IXP425 is booted, it compares the version number of the MASTER and SLAVE firmware stored in main flash with the version numbers recorded on the FPGA flash. If the versions match then the FPGA is allowed to run from its application. If the version numbers do not match then the version in the FPGA flash is updated prior to allowing the FPGA to run. If there is no valid FPGA image in the main flash of the FPGA flash, the IXP425 prints a warning to a console and boots without enabling the FPGA so as to allow a user to load an image via SNMP.

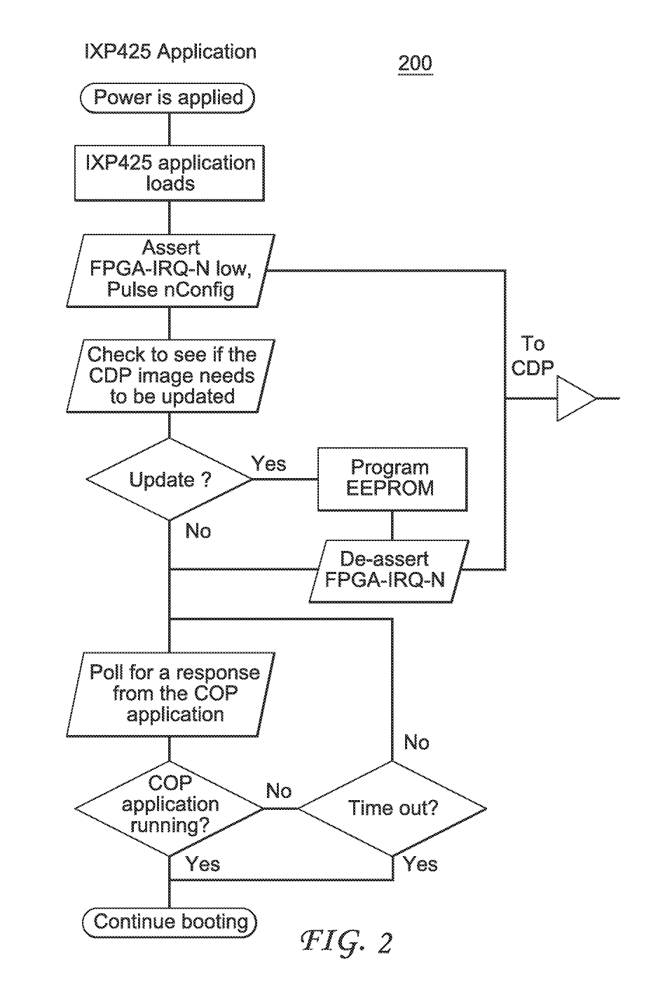

Software upgrades to the FPGA flash are only initiated upon a reboot of the IXP425. FIG. 2 illustrates the IXP425 boot sequence 200 for a given embodiment. In particular, it is noted that if the FPGA does not respond to an attempt to read the version register then the IXP425 prints a warning to the console and continues booting. There is a MIB entry for the MASTER and SLAVE version numbers which is set to 0.0.0 if the image is not valid or the MASTER firmware application image is not valid.

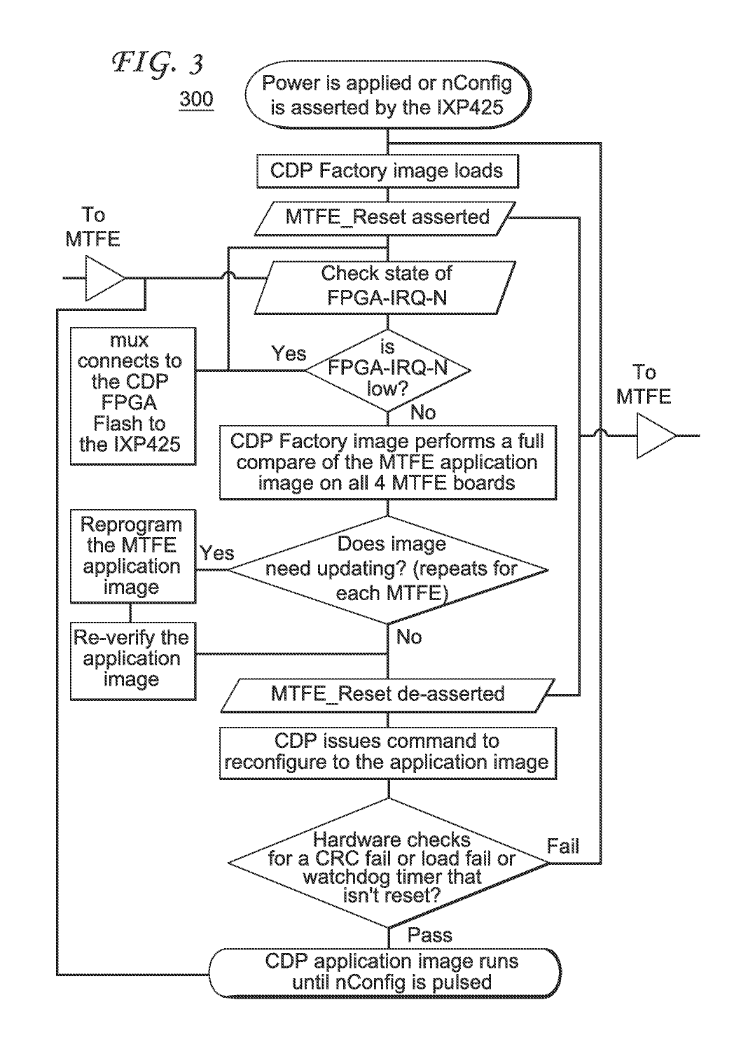

Upon powering up, the MASTER loads its factory image. The factory image for the MASTER instantiates a CPU that manages the verification of the SLAVE firmware. If the firmware in any SLAVE doesn't match, the CPU performs an upgrade. After successfully verifying or loading the SLAVE images, the MASTER factory image loads the application image. The application image runs until it detects a pulse on the nConfig signal. FIG. 3 shows the MASTER boot sequence 300. Much of the boot sequence is dedicated to managing the SLAVE FPGA. The SLAVE always boots off of its factory image, and this firmware enables the loading of the application image. The factory image is stored at location 0x0. This image has a state machine that checks the state of the reset line. If it is low it connects the serial EEPROM lines to the LVDS bus signaling lines. This allows the MASTER to directly read and/or program the SLAVE serial EEPROM.

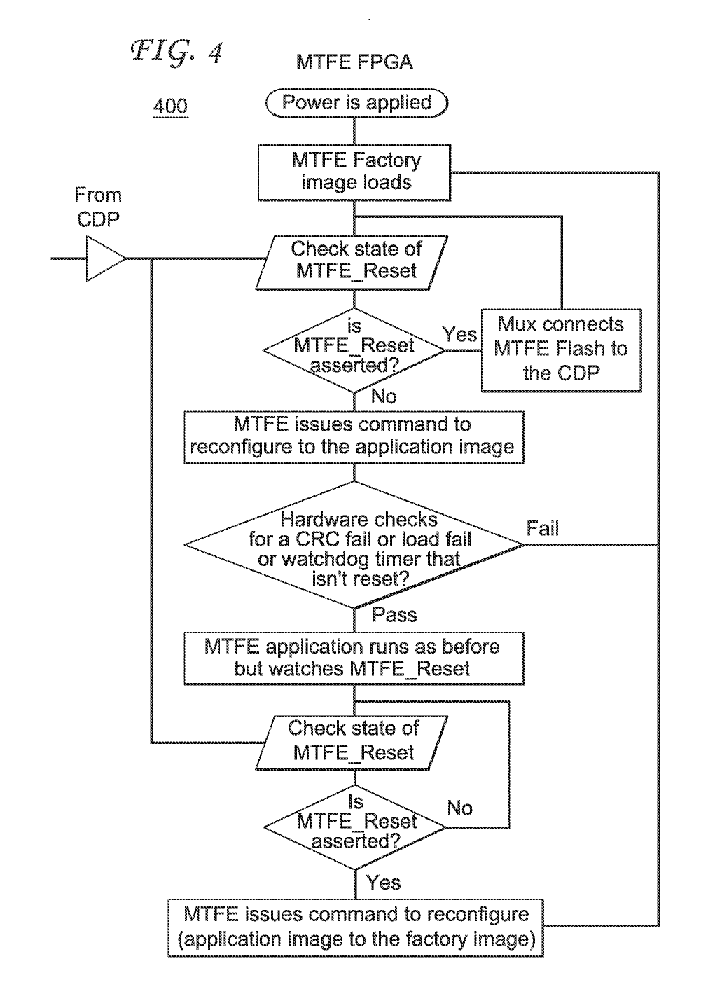

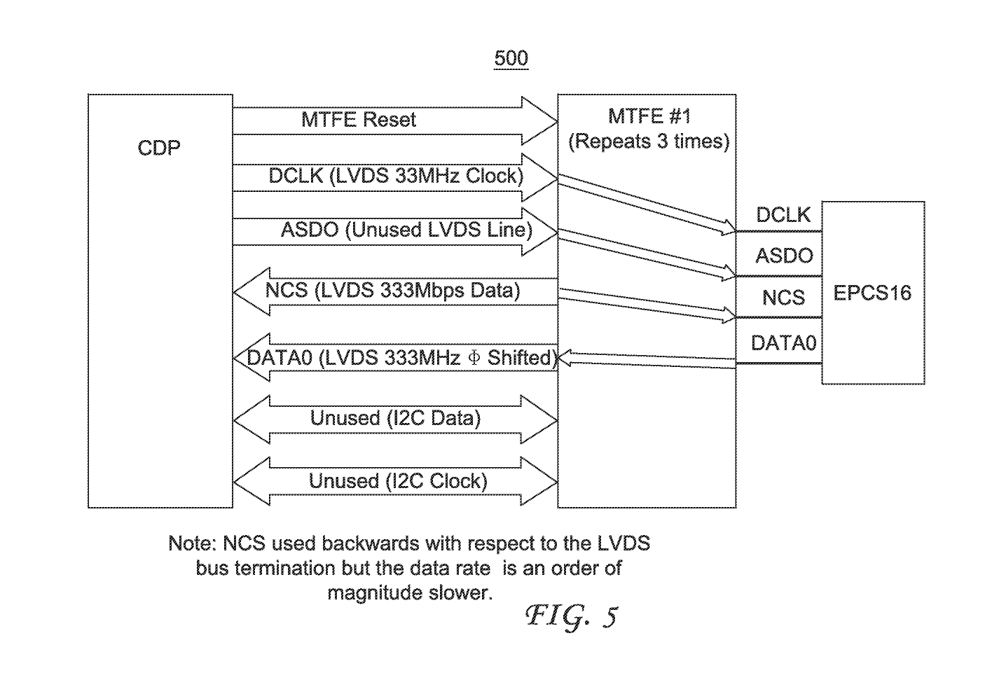

When the reset line goes high, a reconfigure is initiated that reconfigures the SLAVE FPGA using the application image at the address of 0x100000 in the serial EEPROM. This low to high transition is the signal to begin normal operation. While the application is running it watches the SLAVE reset line, and if it is pulled low, a reconfigure command is issued returning it to running the factory image. FIG. 4 depicts a boot sequence 400 for the SLAVE FPGA. It is important to note that the SLAVE FPGA is reset when the MASTER is reset.

### FPGA Application Architecture

The SLAVE FPGA contains eight MPEG transport interfaces, one for each of the on board tuners. The FPGA multiplexes the transport data into a single 333 Mbps LVDS output using 8b/10b encoding. The transmitted signal always has activity because the 8b/10b protocol inserts null bytes when there is no data to send. On startup the LVDS signal gets synchronized by having the receiver shift bits (bit slipping) until the null bytes line up properly in the shift registers. After this is finished sending continuous null byte padding keeps the data lined up.

The MASTER FPGA implements the following:
LVDS Interface to the SLAVE using 8b/10b decoding
DDR Controller
PCI Target Controller
Expansion Bus Interface
PID Filtering State Machine
I2C Controller (4X)
MASTER Data Path

Data from the four SLAVE boards is multiplexed together and then moved via FIFOs through the FPGA. Each MPEG transport packet is inspected. If the Program Identifier (PID) of a packet matches a PID in the FPGA PID filter lookup table, the packet is copied into DDR along with a TCP/IP wrapper provided by the IXP425. The DDR is used as a large buffer to keep data while waiting for it to be sent. When packets are ready to be sent, the IXP425 issues a command to the Ethernet IC allowing it to retrieve packets stored in the FPGA's DDR via 66 MHz 32-bit PCI bus master DMA transfers. This is the primary use of the PCI interface. The IXP425 loads the PID filter data via the expansion bus and has full responsibility for maintaining the table. This table is set by the IXP425 based on the RTSP setup requests coming from the SSB's.

### SLAVE FPGA and MASTER FPGA Communication

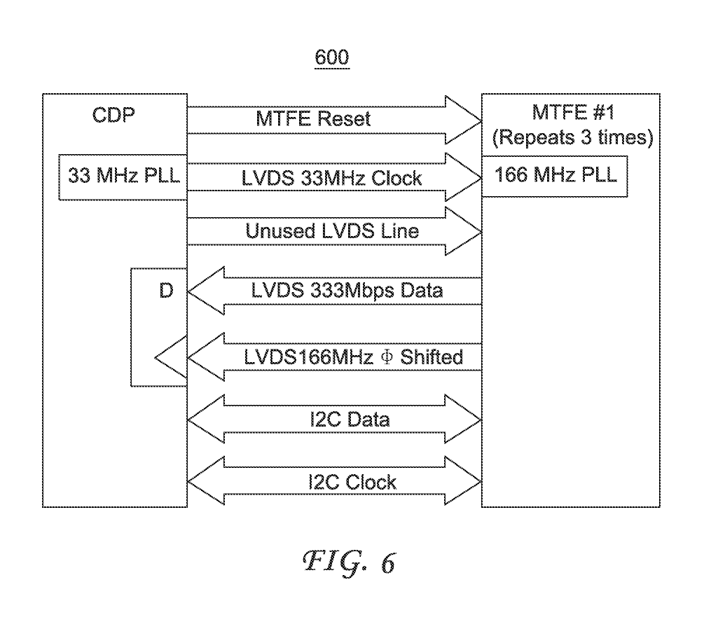

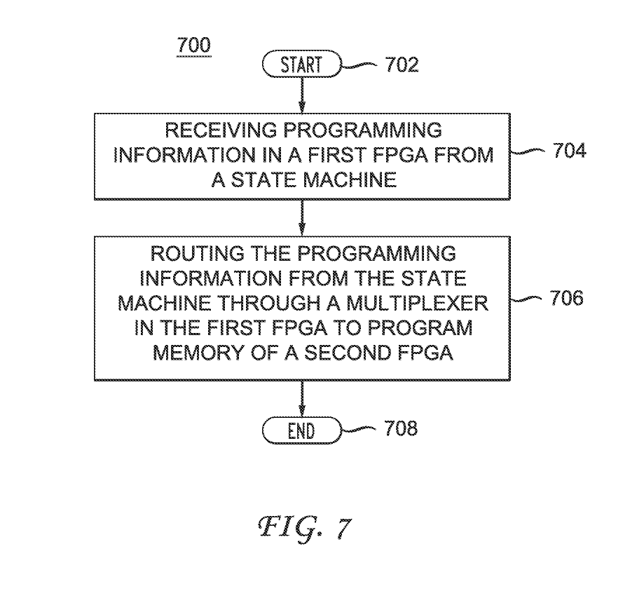

The SLAVE and MASTER communicate with each other over a high speed serial bus. A SLAVE reset line is used to reconfigure the SLAVE FPGA and allow code updates. The MASTER provides a 33 MHz reference clock to the SLAVE. The SLAVE uses a PLL to generate a 166 MHz clock and a second 166 MHz clock that is −90° out of phase. The 166 MHz clock is used to clock the data out of the SLAVE's LVDS data line and the −90° out of phase clock is used to drive the SLAVE's LVDS clock output line. The SLAVE clock and data line are directly connected to a DDR type D flip flop on the MASTER. Setting the clock line out of phase with the data centers the clock in the middle of the time window where the data is valid. These same lines get repurposed when the factory image is loaded. This allows the MASTER to directly reprogram the SLAVE's EPCS16 serial EEPROM. FIG. 5 illustrates the factory image LVDS bus line utilization 500. FIG. 6 shows the application LVDS bus line utilization 600.

In view of the exemplary systems shown and described above, methodologies that can be implemented in accordance with the embodiments will be better appreciated with reference to the flow chart of FIG. 7. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

FIG. 7 is a flow diagram of a method 700 of programming FPGAs. The method starts 702 by receiving programming information in a first FPGA from a state machine 704. In some instantiations, the state machine can be external to the first FPGA. However, the FPGA itself can have a state machine that resides internal to the FPGA. Then the programming information is routed from the state machine through a multiplexer in the first FPGA to program memory of a second FPGA 706, ending the flow 708. The first FPGA can have direct and/or indirect access to the memory of an FPGA. The multiplexer itself is not limited to any number. Thus, the first FPGA can program multiple memories associated with multiple FPGAs. Since the second FPGA is acting as a buffer, there is a greatly reduced chance of multiple FPGA failures due to incorrect and/or interrupted programming attempts.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that programs field programmable gate arrays (FPGAs), comprising:
a first FPGA with a multiplexer that directs programming information to memory associated with a second FPGA; and
a state machine that programs the memory of the second FPGA through the multiplexer in the first FPGA.

2. The system of claim 1, wherein the first and second FPGAs are located on an airplane.

3. The system of claim 1, wherein the first FPGA is in direct control of the memory associated with the second FPGA.

4. The system of claim 1, wherein the first FPGA directs programming information to more than one additional FPGA.

5. The system of claim 1, wherein the state machine is a central processing unit (CPU).

6. The system of claim 1, wherein the second FPGA acts as a buffer during programming.

7. The system of claim 1, wherein the memory is an electrically erasable programmable read-only memory (EEPROM).

8. The system of claim 1, wherein the memory is located at the end of a chain formed by the first and second FPGAs.

9. A method for programming field programmable gate arrays (FPGAs), comprising the steps of:
receiving programming information in a first FPGA from a state machine; and
routing the programming information from the state machine through a multiplexer in the first FPGA to program memory of a second FPGA.

10. The method of claim 9, wherein the state machine is a central processing unit.

11. The method of claim 9 further comprising the step of:
accessing the memory of the second FPGA directly from the first FPGA.

12. The method of claim 9 further comprising the steps of:
receiving programming information associated with more than one FPGA; and
routing the programming information to an associated FPGA through the multiplexer in the first FPGA.

13. The method of claim 9, comprising the step of:
using the second FPGA as a buffer during programming of the memory of the second FPGA.

14. A system that programs field programmable gate arrays, comprising:
a means for receiving programming information in a first FPGA from a central processing unit; and
a means for routing the programming information from the central processing unit through the first FPGA to program memory of a second FPGA.

15. The system of claim 14 further comprising:
a means for routing programming information to more than one memory of more than one FPGA.
